(19) United States
(12) Patent Application Publication
(10) Pub. No.: US 2003/0074188 A1
(43) Pub. Date: Apr. 17, 2003

(54) Method and apparatus for language instruction

(76) Inventors: Tohgo Murata, Sakura (JP); Mari Taira, Inzai (JP)

Correspondence Address: Anthony R. Barkume, Esq., Greenberg Traurig, LLP, 200 Park Avenue, New York, NY, 10166, US

(21) Appl. No.: 09/977,118

(22) Filed: Oct. 12, 2001

(51) Int. Cl. G06F 17/27

(52) U.S. Cl. 704/9

(57) ABSTRACT

Disclosed is a method and apparatus to help English language learners to acquire the customs to think in English with a program built in the apparatus. The program contains typical sentences divided into five parts, each of which is put in one of five cells in a line using a spread sheet. When words and phrases in one of the five cells are displayed in the calculation column, the learner can not see other words and phrases in remaining four cells, hence is given an opportunity to think about them with 5W1H (who, what, where, when, why, how and other words for questions). The apparatus is made up of a display to show the words and phrases in each cell and the whole sentence in additional cell, with some more cells on the same line to show either the photo or animation equivalent to the sentence, or, to give its translation into his own language, for native speakers to give typical pronunciation to the sentence, to add some grammatical notes when each of these cells is clicked. It is also equipped with simple keyboard to point cells in all directions.

### FIELD OF THE INVENTION

This invention relates to a method and apparatus for teaching a foreign language to a student, and in particular relates to such method and apparatus for teaching the English language to a Japanese student.

### BACKGROUND OF THE INVENTION

It is more and more necessary for Japanese people to acquire skills of using the English language in today's global economy conditions. There are already a number of kinds of methods and apparatus on the market to teach English to Japanese people. However, there are few materials to effectively train Japanese people to “think” in English throughout the course of learning.

Typically, the comprehension by Japanese people of English sentences is to listen to them and to read them. The expression in English is to express what is seen as reality, in a photograph or anything imagined, to write and speak in English and to translate from Japanese to English. Conversation in the English language requires skills of comprehension as well as expression.

What is common to these seven skills (listening, reading, watching, writing, speaking, translating and conversation) is to think in English. In most cases for Japanese people to use English, they tend to think in Japanese. This prevents them from learning English effectively.

Any words and phrases in any sentences correspond to one of “5W1H” and some other factors such as who, what, being where, doing what, being how, being whom, being what, where, when, why, how, if and other modifiers to the predicate of a sentence.

People who speak English as their native language are believed to acquire the skill of thinking in English in their infant period. However, once the skill is acquired they are not conscious of the skill yet they can increase number of words and phrases day by day.

On the other hand, people who learn English as second language for instance Japanese try to learn by heart words and phrases or total sentences without the custom of thinking in English. This effort tends to become vain for most Japanese, which makes them feel it difficult to learn English.

This invention presents a method for Japanese to think in English with simple rules and principles using 5W1H.

### SUMMARY OF THE INVENTION

The present invention is in one aspect a method of using a computer to instruct a student to learn the English language. First, a software program such as a spreadsheet 25 program is configured with a plurality of English sentences. Each English sentence is first parsed into a plurality of predefined English sentence parts, and each of the predefined English sentence parts are entered into a corresponding input field of the computer program user interface. The computer program is adapted to display each input field for each sentence entered and concatenate the plurality of input fields to provide a resultant English sentence field for display to a user.

The student is presented with the user interface of the software program, which is further configured to allow the student to select any of the input fields with an input device such as a keyboard or mouse. The student selects a desired input field for a desired sentence entry, and the program displays to the student in a display field of the user interface the entirety of the sentence part contained by the selected input field. Also, the concatenated sentence parts obtained from each of the input field for the selected sentence are displayed to the student in a sentence display field.

As mentioned, the software program may be a spreadsheet program, in which case each input field is a cell in the spreadsheet.

According to the invention, the predefined English sentence parts may comprise a subject, a predicate, an object, a condition, and a pre-subject (any words, phrase or clause preceding the subject). A sentence phrase, comprised of two or more sentence parts, is assembled by the software program and displayed on a display field for viewing by the student.

For each input field, the number of occurrences of each different sentence part input thereto is calculated. The student selects an input field and the calculation results for the input field selected by the student are displayed as the total words he learned.

According to the invention, the subject sentence parts are classified into people (p), things (t), abstract words (a), or pronouns (r),interrogative such who and what, all of which are in either word, phrase or clause. The predicate sentence parts are classified into verb as an existence of a subject (b), verb for action (v), adjective to express a state of a subject (j), people (p), things (t), abstract words (a) or pronouns (r),all of which are in either word, phrase or clause. The object sentence parts are classified into people (p), things (t), abstract words (a) or pronouns (r) all of which are in either word, phrase or clause, object complement such as verb and adjective, noun or pronoun.

The condition sentence parts are classified into place (wr), time (wn), reason (wy), method (hw), if (if), with, by, for and so on. The pre-subject sentence parts are classified into there is/here is(there), interjection (int), adverb word or phrase, clause (adv), conjunction (conj), relative pronoun (rp), interrogative words (wh), or auxiliary verb (ax).

The software program may be configured to store a visual aid file (such as a static image file or an animated image file) in a field associated with each sentence entered, the visual aid file having substantive content related to the subject matter of the associated sentence. The student may then view the visual aid file as part of learning the associated sentence. Likewise, the software program may be configured to store an audio aid file in a field associated with each sentence entered, the audio aid file having substantive content related to the subject matter of the associated sentence. In this case, the student listens to the audio aid file as part of learning the associated sentence. Similarly, the software program may be further configured to store a comment file in a field associated with each sentence entered, the comment file having substantive textual content related to the subject matter of the associated sentence.

The software program may utilize a filter utility adapted to extract selected sentence entries from the database of all sentence entries based on a filter criteria selected by the student, wherein the filter criteria specifies a selection taken from at least one of the input fields. The software program may also use a calculation utility, the calculation utility adapted to provide a total number of occurrences of a sentence part from an input field specified by the student.

In addition to operating on a general computing device such as a personal computer platform, the present invention is also embodied in a dedicated handheld housing with a display screen, and processing means(such as keys to select cells) within the housing programmed as mentioned herein.

### BRIEF DESCRIPTION OF THE DRAWING

FIG. 1 is an illustration of the condensed graphical layout of the present invention showing four sample sentence lines;

FIGS. 2a, 2b and 2c illustrate the expanded graphical layout of FIG. 1;

FIG. 3 is an illustration of a networked-based computer system that allows a user to interact with a language instruction server in accordance with the present invention;

FIG. 4 is an illustration of a hand-held embodiment of the present invention; and

FIG. 5 is an illustration of the condensed graphical layout of FIG. 1 with a drop-down filter selection list.

### DETAILED DESCRIPTION OF THE INVENTION

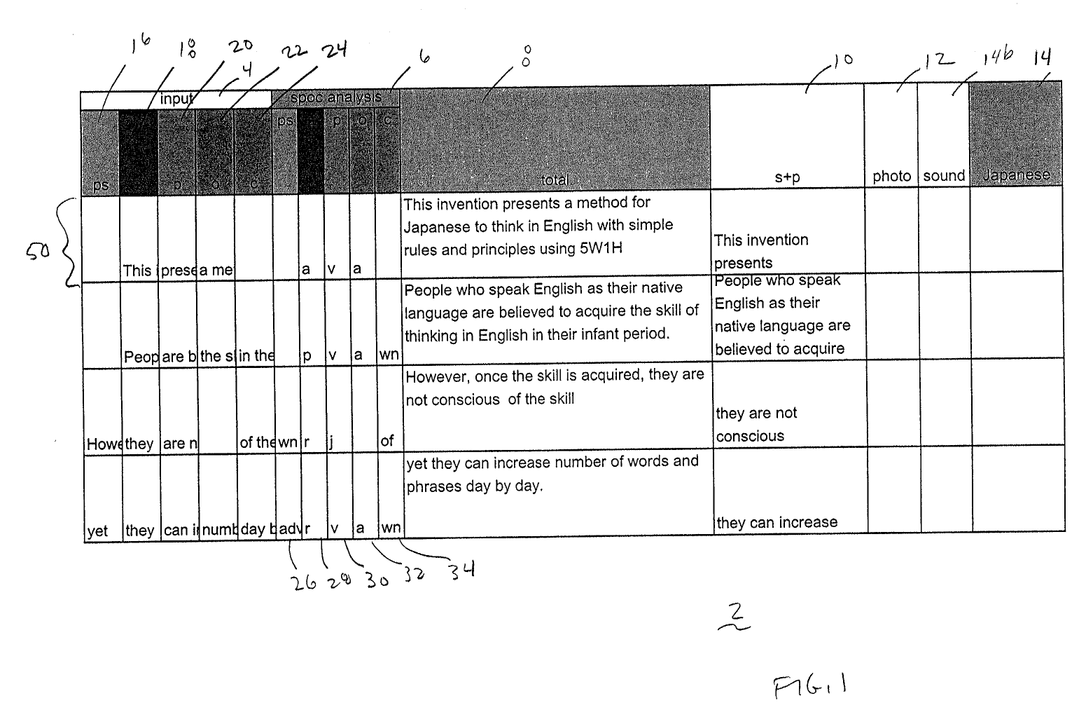

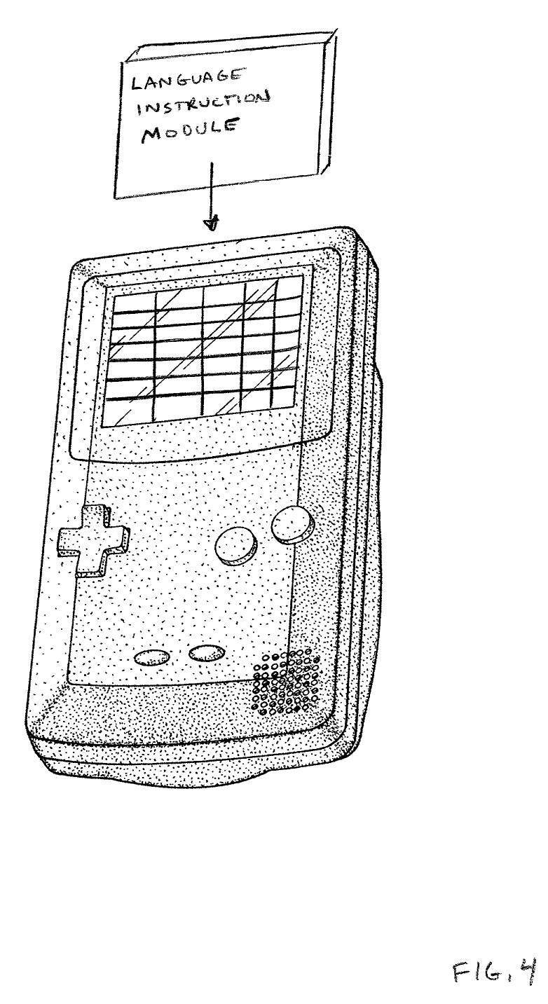

The preferred embodiment of the present invention will now be described. FIG. 1 illustrates the condensed graphical layout 2 of the present invention showing four sample sentence lines. This graphical layout 2 would typically be displayed on a computer monitor screen or on a display screen of a hand-held device embodiment as shown in FIG. 4 and described further below.

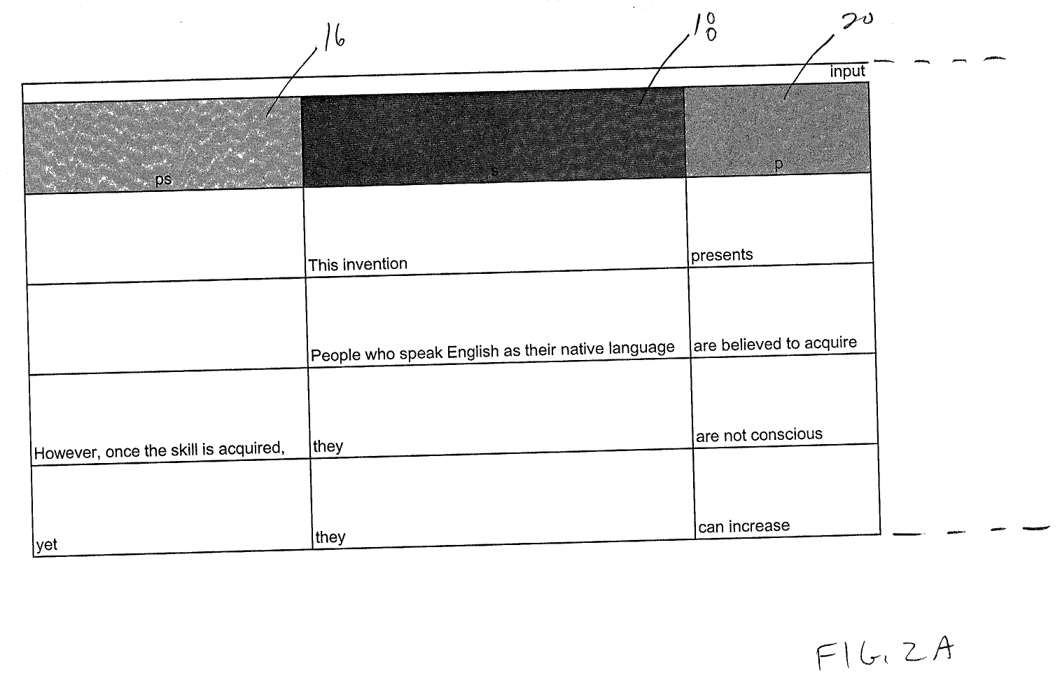

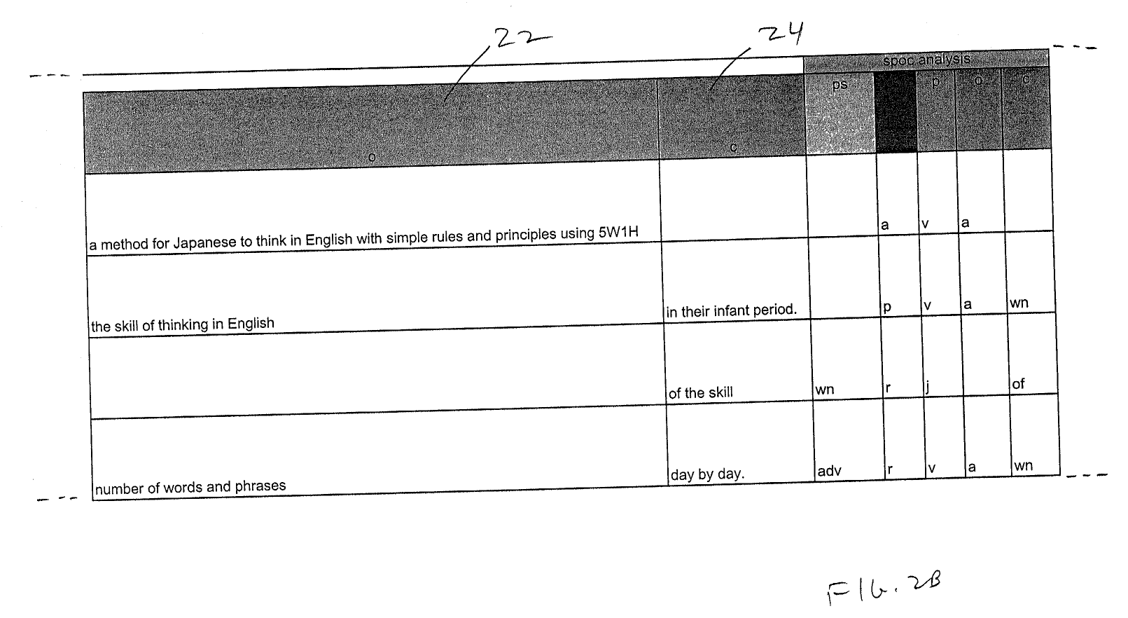

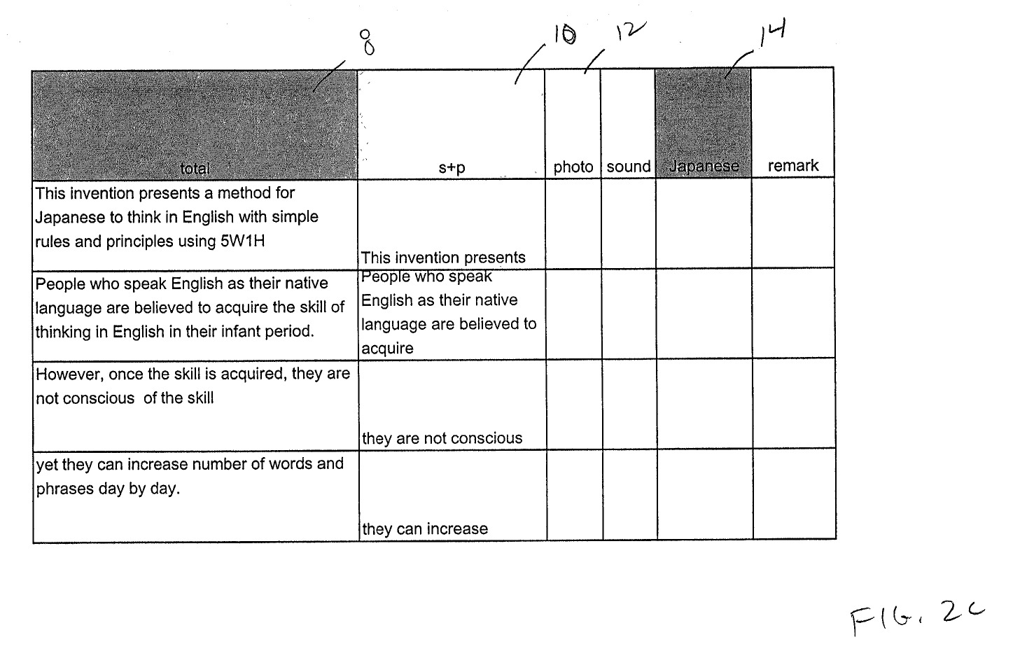

In the preferred embodiment, the spreadsheet software program EXCEL by MICROSOFT Corp. is utilized on a standard personal computer platform commonly available today. By using this spreadsheet format, the various fields may be selectively expanded and compressed as desired by the user in accordance with the display monitor size available for use. That is, due to the large number of fields being implemented, the user may want to compress the width of one or more of the fields so that the entire (or most of the) spreadsheet can be seen on the display at one time. In the alternative, the user can select any given field and expand it as well known in the art (e.g. by dragging the field boundaries as desired with a mouse). FIGS. 2a, 2b, and 2c illustrate the display with several of the fields expanded for ease of viewing the contents thereof.

With reference to FIGS. 1 and 2a, 2b and 2c, the graphical layout 2 comprises a plurality of input fields 4, analysis fields 6, a total sentence field 8, an S&P (subject and predicate) field 10, an image field 12 and a native language field 14 (Japanese in the preferred embodiment),a sound field 14b. The input fields 4 are comprised of a presubject field 16, a subject field 18, a predicate field 20, an object field 22, and a condition field 24. The analysis fields 6 are comprised of a presubject column 26, a subject column 28, a predicate column 30, an object column 32, a c column 34. However, any new field can be added when it becomes necessary to add new factor or other analysis.

The invention will be explained with reference to sample sentence 50, which as shown in total sentence field 8 is:

“This invention presents a method for Japanese to think in English with simple rules and principles of 5W1H.”

This sentence is parsed into several logical portions as follows:

Presubject: -

Subject: This invention

Predicate: presents

Object: a method for Japanese to think in English with simple rules and principles of 5W1H

Condition: -

These sentence portions are entered into the appropriate fields as shown in the figures. If a sentence does not contain a particular sentence part (e.g. the above example has no presubject field), then that field may be left blank for that sentence. The S&P field 10 may also be filled with the concatenation of the subject and predicate, which in this example is the phrase “This invention presents”.

Optionally, the photo or image field 12 may be provided with a suitable image file (e.g. JPEG. GIF, BMP, etc.) that will display in a visual format to the user the message that is conveyed by the sentence being learned. For example, if the sentence being learned is “The dog was barking at the children,” then a graphic of a dog barking at children could easily be inserted (or referenced with a hyperlink) into the image field 12 as an aid in learning the sentence.

Likewise, the natural language equivalent of the sentence being learned (e.g. Japanese in the preferred embodiment) may be inserted into the field 14 as an aid for the user of the system. The user can switch between the English version of the sentence and the Japanese version to help him or her learn the English version properly and understand its meaning.

The analysis fields 6 may be used by the learner to allow characterization of various sentences and/or parts thereof and insertion into such fields of any kind of text as an aid in learning the associated sentence. For example, the learner of the sentence 50 has entered “a” into the subject field 28, indicating that the subject of the sentence is a “abstract”. When the user reads the sentence fields for sentence 50, seeing the “a” in the subject field 28 will clue him into the fact that the subject “This invention” refers to an abstract (as opposed to a place or thing). Other classifications for the analysis fields are things (t), person (p), or pronouns (r).

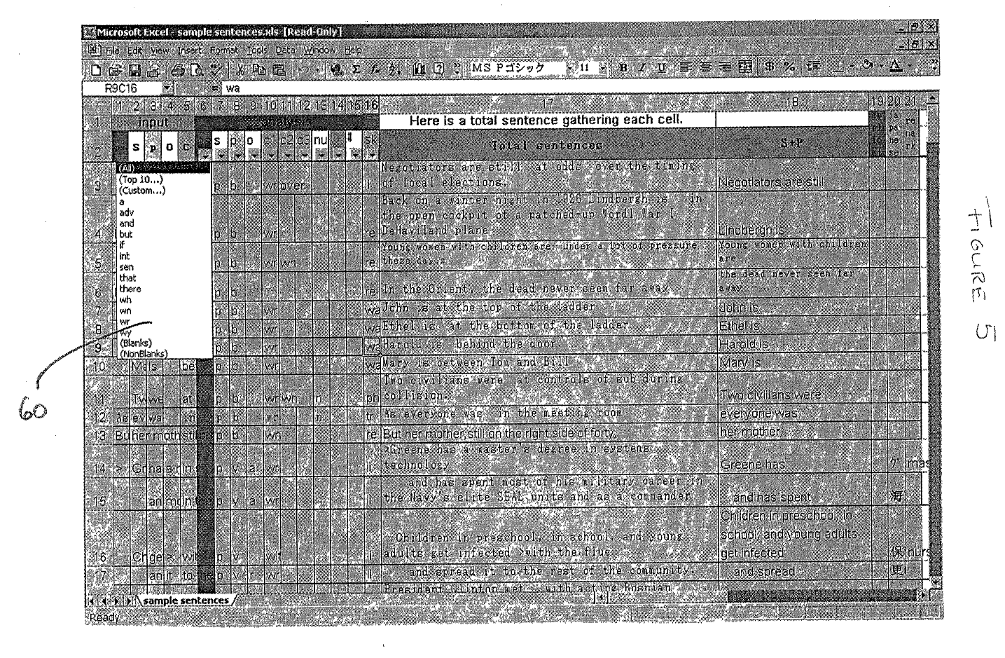

FIG. 5 illustrates the use of a drop-down filter function that can be used in conjunction with the analysis fields 6. The drop-down filter list 60 is utilized as an analysis tool to filter only those sentences that contain the parameter selected by the user. For example, the user can drop down a subject list and select the “p” parameter, and the spreadsheet program will filter and display only those sentences wherein the programmer has designated the subject to be a “p” (i.e. a person). This will allow the user to concentrate on sample sentences of that genre and this will be helpful in learning the English sentences presented as a result of the filter operation.

The predicate sentence parts may be classified in the appropriate predicate analysis field 30 as one of the following types:

verb as an existence of a subject (b),

verb for action (v),

adjective to express a state of a subject (j),

people (p),

things (t),

abstract words (a), or

pronouns (r).

Thus, the programmer will designate the predicate for a given input sentence as one of the above predicate types and make the appropriate entry into the predicate analysis field 30 for viewing, filtering, etc. by the user.

Likewise, the object sentence parts may be classified in the appropriate object analysis field 32 as one of the following types:

people (p),

things (t),

abstract words (a), or

pronouns (r).

object complement (oc)

Thus, the learner will designate the object for a given input sentence as one of the above object types and make the appropriate entry into the object analysis field 32 for viewing, filtering, etc. by the user.

Further, the condition sentence parts may be classified in the appropriate condition analysis fields 34, 36 and/or 38 as one of the following types:

place (wr),

time (wn),

reason (wy),

method (hw),

if (if),

by, with, for and so on.

The programmer will designate the condition(s) for a given input sentence as one of the above condition types and make the appropriate entry into the condition analysis fields 34, for viewing, filtering, etc. by the user.

However, factors in the predicate can be modified only to “be verb” (b) and “do verb” (v), in addition, when modified like this, the object can be changed to complement such as adjective, noun(indicating people, things, abstract), object and object complement such as verb and adjective. Like this, the combination of each factors are not limited to the description of the patent.

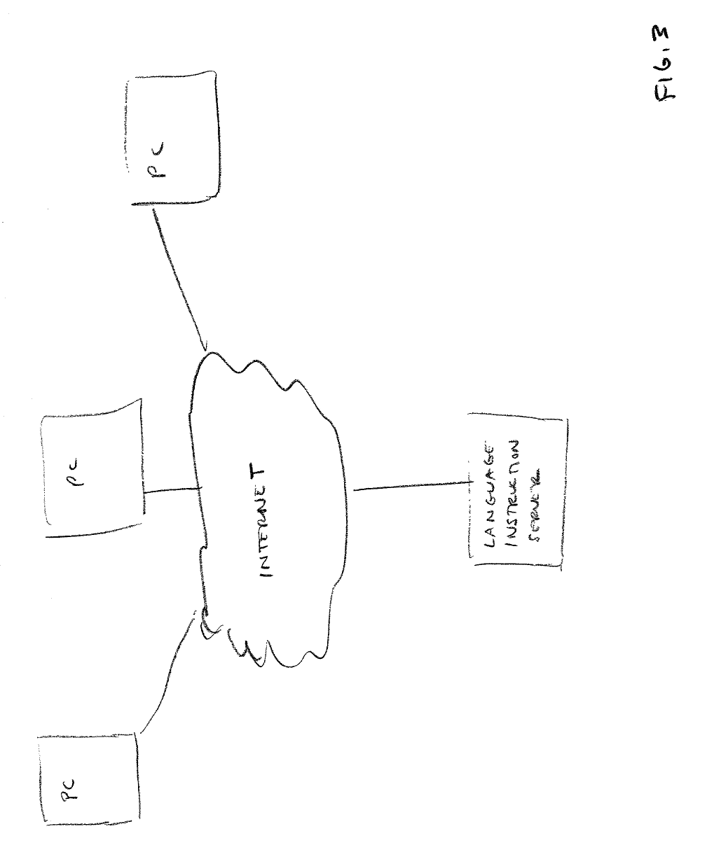

The spreadsheet-based program may be populated with any reasonable number of sentences and sentence parts as above described, and marketed as desired to users that require foreign language instruction. Thus, a Japanese student of the English language may purchase the software program populated with hundreds or even thousands of sentences as described, at varying levels of complexity. As shown in FIG. 3, the user may interconnect to a server computer over the Internet in order to download the software, obtain updates and new sentences for review, etc, by communicating with the language instruction server computer illustrated therein, which stores the database of available sentences as described above.

In an alternative embodiment shown in exemplary format in FIG. 4, a hand-held device may be utilized having a display screen, and processing functions for utilizing the sentence instruction programs of the present invention. In this way, a user can carry the instructional program with him in a portable manner. The instruction software may be dedicated within the unit, or it may be resident on a software cartridge as shown in the Figure for insertion into a general purpose handheld device such as a PDA or game player as well known in the art.

What is claimed is:

1. A method of using a computer to instruct a student to learn the English language comprising the steps of:
a) configuring a software program with a plurality of English sentences, each English sentence being entered by the steps of:
i) parsing the English sentence into a plurality of predefined English sentence parts;
ii) entering each of said predefined English sentence parts into a corresponding input field of a computer program user interface; wherein the computer program is adapted to:
display each input field for each sentence entered and
concatenate the plurality of input fields to provide a resultant English sentence field for display to a user;
b) presenting the student with the user interface of the software program, the software program configured to allow the student to select any of the input fields with an input device;
c) the student selecting a desired input field for a desired sentence entry;
d) displaying to the student in a display field of the user interface the entirety of the sentence part contained by the selected input field;
e) displaying to the student in a sentence display field the concatenated sentence parts obtained from each of the input field for the selected sentence.

2. The method of claim 1 wherein the software program is a spreadsheet program, and wherein each input field is a cell in the spreadsheet.

3. The method of claim 1 wherein the predefined English sentence parts comprise a subject, a predicate, an object, a condition, and a pre-subject.

4. The method of claim 1 wherein a sentence phrase, comprised of two or more sentence parts, is assembled by the software program and displayed on a display field for viewing by the student.

5. The method of claim 1 further comprising the steps of
for each input field, calculating the number of occurrences of each different sentence part input thereto,
the student selecting an input field, and displaying the calculation results for the input field selected by the student.

6. The method of claim 3 wherein the subject sentence parts are classified into:
people (p),
things (t),
abstract words (a),
pronouns (r), or
interrogative.

7. The method of claim 3 wherein the predicate sentence parts are classified into:
verb as an existence of a subject (b),
verb for action (v),
adjective to express a state of a subject (j),
people (p),
things (t),
abstract words (a), or
pronouns (r).

8. The method of claim 3 wherein the object sentence parts are classified into:
people (p),
things (t),
abstract words (a),
pronouns (r), or
object complement such as verb, adjective, noun or
pronoun.

9. The method of claim 3 wherein the condition sentence parts are classified into:
place (wr),
time (wn),
reason (wy),
method (hw),
if (if),
by, with, for and so on.

10. The method of claim 3 wherein the pre-subject sentence parts are classified into:
there is/here is (there)
interjection (int),
adverb word phrase, or clause (adv),
conjunction (conj),
relative pronoun (rp),
interrogative words (wh), or
auxiliary verb (ax).

11. The method of claim 1 wherein the software program is further configured with store a visual aid file in a field associated with each sentence entered, the visual aid file having substantive content related to the subject matter of the associated sentence.

12. The method of claim 11 wherein the visual aid files comprise a static image file.

13. The method of claim 11 wherein the visual aid files comprise an animated image file.

14. The method of claim 11 wherein the student views the visual aid file as part of learning the associated sentence.

15. The method of claim 1 wherein the software program is further configured with store an audio aid file in a field associated with each sentence entered, the audio aid file having substantive content related to the subject matter of the associated sentence.

16. The method of claim 11 wherein the student listens to the audio aid file as part of learning the associated sentence.

17. The method of claim 1 wherein the software program is further configured with store a comment file in a field associated with each sentence entered, the comment file having substantive textual content related to the subject matter of the associated sentence.

18. The method of claim 3 further comprising the step of providing the student with a filter utility, the filter utility adapted to extract selected sentence entries from the database of all sentence entries based on a filter criteria selected by the student, the filter criteria specifying a selection taken from at least one of the input fields.

19. The method of claim 3 further comprising the step of providing the student with a calculation utility, the calculation utility adapted to provide a total number of occurrences of a sentence part from an input field specified by the student.

20. An apparatus for instructing a student to learn the English language comprising:
I) a housing suitable for being held in the hand of a student;
II) a display screen attached to the housing
III) computer processing means integrated within the housing, adapted to:
a) store a plurality of English sentences and predefined sentence parts into a plurality of input fields of a computer program;
b) display to the student the user interface of the software program, the software program configured to allow the student to select any of the input fields with the input means;
c) display to the student in a display field of the user interface the entirety of the sentence part contained by the selected input field;
e) display to the student in a sentence display field the concatenated sentence parts obtained from each of the input field for the selected sentence.

21. The apparatus of claim 20 wherein the software program is a spreadsheet program, and wherein each input field is a cell in the spreadsheet.

22. The apparatus of claim 20 wherein the predefined English sentence parts comprise a subject, a predicate, an object, a condition, and a pre-subject.

23. The apparatus of claim 20 wherein a sentence phrase, comprised of two or more sentence parts, is assembled by the software program and displayed on a display field for viewing by the student.

24. The apparatus of claim 20 wherein for each input field, the processing means calculates the number of occurrences of each different sentence part input thereto, and upon the student selecting an input field via the input means, the calculation results for the input field selected by the student is displayed on the display screen.

25. The apparatus of claim 23, wherein the subject sentence parts are classified into:
people (p),
things (t),
abstract words (a),
pronouns (r), or
interrogative (wh).

26. The apparatus of claim 23, wherein the predicate sentence parts are classified into:
verb as an existence of a subject (b),
verb for action (v),
adjective to express a state of a subject (j),
people (p),
things (t),
abstract words (a), or
pronouns (r).

27. The apparatus of claim 23, wherein the object sentence parts are classified into:
people (p),
things (t),
abstract words (a),
pronouns (r),or
object complement such as verb, adjective, noun or
pronoun.

28. The apparatus of claim 23, wherein the condition sentence parts are classified into:
place (wr),
time (wn),
reason (wy),
method (hw),
if (if), with, by, for and so on.

29. The apparatus of claim 23, wherein the pre-subject sentence parts are classified into:
there is/here is (there)
interjection (int),
adverb word or phrase (adv),
conjunction (conj),
relative pronoun (rp),
interrogative words (wh), or
auxiliary verb (ax).

30. The apparatus of claim 20, wherein the software program is further configured to store a visual aid file in a field associated with each sentence entered, the visual aid file having substantive content related to the subject matter of the associated sentence, and wherein the visual aid file is displayed on the display screen when selected via the input means.

31. The apparatus of claim 30, wherein the visual aid files comprise a static image file.

32. The apparatus of claim 30, wherein the visual aid files comprise an animated image file.

33. The apparatus of claim 20 wherein the software program is further configured with store an audio aid file in a field associated with each sentence entered, the audio aid file having substantive content related to the subject matter of the associated sentence, and wherein the audio aid file is played via an audio output device associated with the housing when selected via the input means.

34. The apparatus of claim 20 wherein the software program is further configured with store a comment file in a field associated with each sentence entered, the comment file having substantive textual content related to the subject matter of the associated sentence.

35. The apparatus of claim 23 wherein the software program is further adapted with a filter utility, the filter utility adapted to extract selected sentence entries from the database of all sentence entries based on a filter criteria selected by the student, the filter criteria specifying a selection taken from at least one of the input fields.

36. The apparatus of claim 23 wherein the software program is further adapted with a calculation utility, the calculation utility adapted to provide a total number of occurrences of a sentence part from an input field specified by the student.
